(19) United States
(12) Patent Application Publication
(10) Pub. No.: US 2008/0112087 A1
(43) Pub. Date: May 15, 2008

(54) WAMR writer with an integrated spin momentum transfer driven oscillator for generating a microwave assist field

(75) Inventors: Thomas William Clinton, Pittsburgh, PA (US); Sharat Batra, Wexford, PA (US); Shehzaad Kaka, Pittsburgh, PA (US); Werner Scholz, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/598,932

(22) Filed: Nov. 14, 2006

(51) Int. Cl. G11B 5/127; G11B 5/33

(52) U.S. Cl. 360/317; 360/125.3

(57) ABSTRACT

An apparatus comprises a write pole, a return pole, a wire positioned between the write pole and the return pole, a first free layer, and a first interlayer positioned between the write pole and the first free layer.

### FIELD OF THE INVENTION

This invention relates to magnetic recording heads, and more particularly to such heads that include a WAMR writer and a radio frequency source.

### BACKGROUND OF THE INVENTION

As bit areal densities in magnetic recording continue to progress in an effort to increase the storage capacity of hard disc drives, magnetic transition (i.e., bit) dimensions and, concomitantly, recording head critical features are being pushed below 100 nm. In a parallel effort, to make the recording medium stable at higher areal densities, magnetically harder (i.e., high coercivity) medium materials are required. Traditionally, writing to a harder medium has been achieved by increasing the saturation magnetization, or 4πMₛ value, of the magnetic material comprising the inductive write head, thus bolstering the magnetic field applied to the medium. Though there has been some success in materials research efforts to increase Mₛ of the write head, the rate of increase is not significant enough to sustain the annual growth rate of bit areal densities in disc storage. Further, continued increases in Mₛ are likely unsustainable as the materials reach their fundamental limits. A consequence of higher areal densities is an increase in data rates. Data rates are advancing toward a GHz and beyond, where it becomes increasingly difficult to switch the magnetization of the recording medium using a conventional write field applied antiparallel to the magnetization direction.

Thus, there is a need for a writing process capable of switching higher coercivity media at increasingly high data rates.

### SUMMARY OF THE INVENTION

In a first aspect, the invention provides an apparatus comprising a write pole, a return pole, a wire positioned between the write pole and the return pole, a first free layer, and a first interlayer positioned between the write pole and the first free layer.

In another aspect, the invention provides an apparatus comprising a write pole, a return pole, a wire positioned between the write pole and the return pole, a first magnetic stack, a second magnetic stack, and a depolarization layer positioned between the first and second magnetic stacks.

In another aspect, the invention provides an apparatus comprising a write pole, a return pole, a wire positioned between the write pole and the return pole, and a first radio frequency field source. The first radio frequency field source can be phase locked with a second radio frequency field source.

In another aspect, the invention provides an apparatus comprising a write pole, a return pole, and a first radio frequency field source that is phase locked with a second radio frequency field source.

### BRIEF DESCRIPTION OF THE DRAWINGS

FIGS. 1 and 2 are schematic diagrams that illustrate the magnetization directions.

FIGS. 3, 4 and 5 are schematic representations of spin momentum transfer stacks.

FIG. 6 is an isometric view of a recording head constructed in accordance with an embodiment of the invention.

FIG. 7 is a plan view of an air bearing side of a recording head constructed in accordance with an embodiment of the invention.

FIG. 8 is a plan view of an air bearing side of a spin momentum transfer stack.

FIG. 9 is a schematic representation of a portion of a magnetic recording head constructed in accordance with an embodiment of the invention.

FIGS. 10 and 11 are plan views of an air bearing side of recording heads constructed in accordance with embodiments of the invention.

FIG. 12 is a cross-sectional view of the recording head of FIG. 11.

FIG. 13 is a plan view of an air bearing side of a recording head constructed in accordance with an embodiment of the invention.

FIG. 14 is a plan view of an air bearing side of a spin momentum transfer stack.

FIG. 15 is a schematic representation of a portion of a magnetic recording head constructed in accordance with an embodiment of the invention.

FIG. 16 is a plan view of an air bearing side of a recording head constructed in accordance with an embodiment of the invention.

FIG. 17 is a schematic representation of a portion of a magnetic recording head constructed in accordance with an embodiment of the invention.

FIG. 18 is a plan view of an air bearing side of a recording head constructed in accordance with an embodiment of the invention.

FIG. 19 is a schematic representation of a portion of a magnetic recording head constructed in accordance with an embodiment of the invention.

FIG. 20 is a plan view of an air bearing side of a recording head constructed in accordance with an embodiment of the invention.

FIG. 21 is a plan view of an air bearing side of a spin momentum transfer stack.

FIG. 22 is a schematic representation of a portion of a magnetic recording head constructed in accordance with an embodiment of the invention.

FIG. 23 is a plan view of an air bearing side of a recording head constructed in accordance with an embodiment of the invention.

FIG. 24 is a schematic representation of a portion of a magnetic recording head constructed in accordance with an embodiment of the invention.

FIG. 25 is a plan view of an air bearing side of a recording head constructed in accordance with an embodiment of the invention.

FIG. 26 is a schematic representation of a portion of a magnetic recording head constructed in accordance with an embodiment of the invention.

FIG. 27 is a plan view of an air bearing side of a recording head constructed in accordance with an embodiment of the invention.

FIG. 28 is a plan view of an air bearing side of a spin momentum transfer stack.

FIG. 29 is a plan view of an air bearing side of a recording head constructed in accordance with an embodiment of the invention.

FIG. 30 is a plan view of an air bearing side of a spin momentum transfer stack.

FIG. 31 is a graph of a current and voltage signal.

FIGS. 32, 33 and 34 are plan views of an air bearing side of recording heads constructed in accordance with embodiments of the invention.

### DETAILED DESCRIPTION OF THE INVENTION

One type of magnetic write head is energized and field-amplified by a wire positioned adjacent to a write pole at an Air Bearing Surface (ABS). The wire that is used to produce the write field is referred to as an ampere wire. The ampere wire can generate large local magnetic fields (>kOe) by way of large current densities (˜10⁹ A/cm²) in a thin-film wire. This type of recording head is referred to as a Wire Amplified Magnetic Recording (WAMR) head. The flux density from the ampere wire can be high enough to magnetize the write pole(s) and generate enough additional flux density with an appropriate field direction and spatial profile to augment the write field. In addition to an increased field magnitude, the field profile from the wire, maps onto that of the write pole so as to yield improved field gradients.

Spin momentum transfer (SMT) between fixed and free layers of a magnetic multilayer structure can be used to induce the continuous precession of the free layer magnetization. In this way, a direct current (DC) can drive an oscillating magnetic field and voltage. An oscillating field with a frequency near the effective magnetic resonance of a storage medium can be used to “soften” the medium during a writing process.

In one aspect, this invention provides a perpendicular Wire Amplified Magnetic Recording (WAMR) head with an integrated SMT oscillator to further improve WAMR writability. The SMT device produces a radio frequency (rf) assist field that superposes with the WAMR field. As used in this description, rf refers generally to microwave frequencies. The SMT oscillator can also be phase locked to another rf source (e.g., an additional SMT device and/or an external source) to bolster its power output and increase the spatial range of the assist field it generates. This concept makes it possible to write to higher anisotropy media, and thus, enables higher areal density writing.

This invention utilizes the magnetization dynamics of the magnetic medium, as well as magnetic materials in the writer to achieve efficient writing to the medium. First consider the media, where a simple model that describes the dynamics of a single-domain magnetization M in the presence of a magnetic field H is expressed by the Landau-Lifshitz equation,

$$\frac{d M}{d t} = - \frac{{μ}_{0} γ}{( 1 + {α}^{2} )} M \times H - \frac{{μ}_{0} γ α}{{M}_{S} ( 1 + {α}^{2} )} M \times ( M \times H ) , \qquad ( 1 )$$

where γ is the gyromagnetic ratio (=28 GHz/T) and α is the damping parameter. The first term describes precessional motion of the magnetization M about the field H, while the second term represents damping of the motion and ultimately will force M to relax along H.

On the timescales of a conventional write process, the switching is best described by the full expression in Eq. 1, as damping plays a significant role in the dynamics of the magnetization of the storage medium, where M ultimately relaxes along the effective direction of the write field, M∥H_{write}, parallel to the easy axis of the storage medium. Additionally, a writing process using a complementary transverse (or “in-plane” for perpendicular recording) field has the benefit of increasing the torque, T, applied to the magnetization, where T=|M∥H|sin θ(=|M×H|), and θ is the angle between M and H. The torque is maximized when the in-plane field oscillates resonantly with the effective precessional frequency (fₒ) of the magnetization. In the case of magnetic storage media, the resonant frequency is a function of the material's self fields, such as anisotropy, Hₖ, and saturation magnetization, 4πMₛ, as well as the external field, H_{write}.

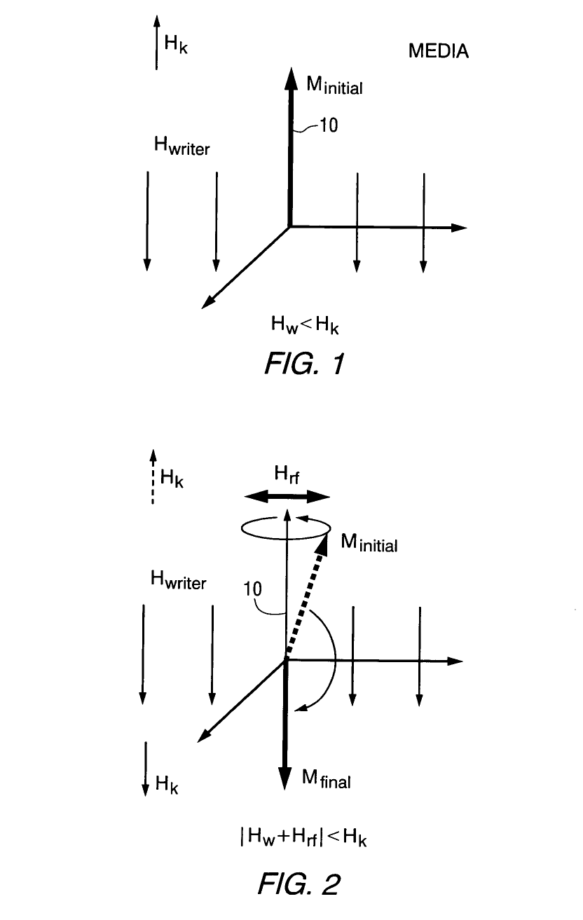

The precessionally-assisted switching process is schematically depicted in FIGS. 1 and 2. FIG. 1 depicts the magnetization in an initial state Mᵢₙᵢₜᵢₐₗ along the magnetic easy axis 10 of a perpendicular storage medium. A write field H_{writer} is applied antiparallel to M such that H_{writer}<Hₖ, which, consequently, is not sufficient to reverse M. FIG. 2 describes the addition of an in-plane rf field H_{rf} that resonantly torques the magnetization M such that the net write field [H_{w}+H_{rf}(f)] is sufficient to reverse the magnetization M_{final}, even when the magnitude of the net field is less than Hₖ, |H_{w}+H_{rf}(f)|≦|Hₖ|. Although an in-plane rf magnetic field applies the maximum torque to a perpendicular magnetization, the rf magnetic field does not have to be exclusively in-plane.

Next consider the magnetization dynamics of the field-delivery concept as they apply to the writing process outlined above. When a spin-polarized current passes through a magnetic material, the transfer of angular momentum from the spins exerts a torque on the magnetic moment of the material. In magnetic stacks (also referred to as magnetic bilayers) having a fixed, or reference, magnetic layer and a free layer, the spin-polarized current transfers angular momentum from the fixed layer to the free layer, exerting a torque on the free layer. The Landau-Lifshitz equation (Eq. 1) can again be applied, in this case to describe the free layer dynamics, by incorporating the effects on the magnetization from a spin-polarized current,

$$\frac{d {M}_{free}}{d t} = - \frac{{μ}_{0} γ}{( 1 + {α}^{2} )} {M}_{free} \times H - \frac{{μ}_{0} γ α}{{M}_{Sfree} ( 1 + {α}^{2} )} {M}_{free} \times ( {M}_{free} \times H ) + \frac{ℏ}{2 e} \frac{ɛ \cdot I}{V} \frac{γ}{( 1 + {α}^{2} ) {M}_{Sfree}^{2} {M}_{Sfixed}} {M}_{free} \times ( {M}_{free} \times {M}_{fixed} ) \qquad ( 2 )$$

where I is the current flowing perpendicular to the plane (CPP) of the magnetic layers, M_{Sfree} is the free layer saturation magnetization, M_{Sfixed} is the fixed layer saturation magnetization, ε is an efficiency factor related to the spin-polarization of the current, and V is the volume of the free layer. Solutions to this equation yield a critical current, I_{c}, beyond which the magnetization of the free layer can be driven either parallel or antiparallel to the fixed layer, depending on the direction of current flow.

The critical current, or current density J_{c} (=I_{c}t/V), depends on several variables, such as the magnetic field and the physical parameters of the free layer,

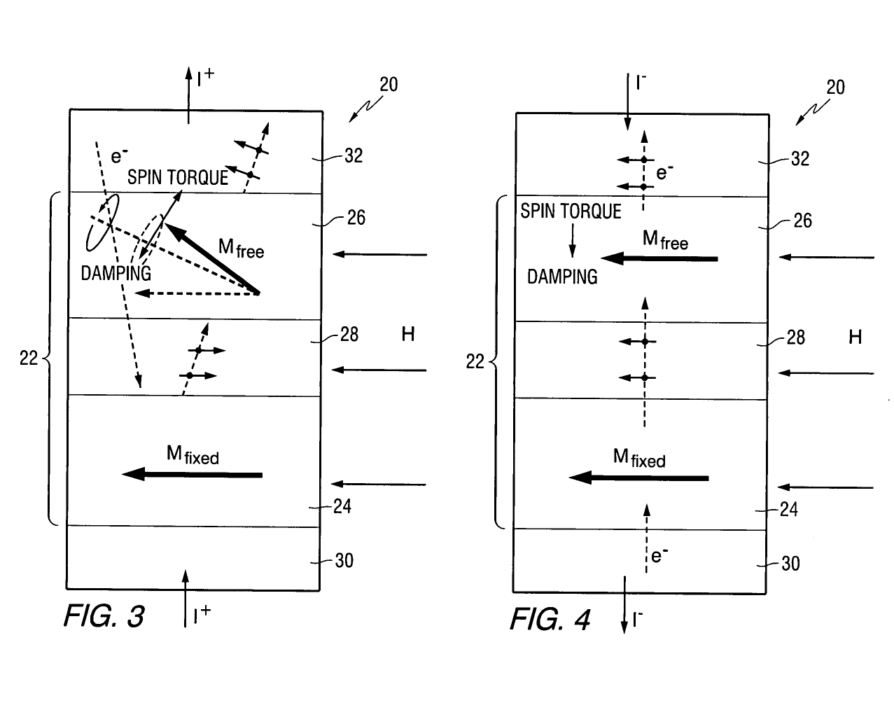

J_{c}∝α·t(H±Mₛ), (3)

where t is the free layer thickness. FIGS. 3 and 4 are schematic representations of a spin momentum transfer stack 20 including a magnetic stack, or bilayer 22, that depicts the effect of a spin current in a CPP bilayer. The magnetic bilayer 22 includes a fixed magnetic layer 24 and a free magnetic layer 26 separated by an interlayer 28. Electrodes 30 and 32 are positioned on opposite sides of the magnetic bilayer and electrically connected to the magnetic bilayer. A current source, not shown in these views, supplies a bias current I to the magnetic bilayer. H is an externally applied field.

FIG. 4 shows a negative bias current (I⁻) where electron flow is from bottom to top. There is an applied magnetic field H along the fixed layer magnetization direction that aligns the magnetizations of the fixed and free layers. The electron spins going from the fixed layer to the free layer exert a torque on the free layer magnetization that drives it parallel to the direction of magnetization of the fixed layer, preserving the parallel alignment. FIG. 3 shows a positive bias (I⁺) where the electron flow is from top to bottom, which, by time-reversal symmetry, is equivalent to a reverse flow of oppositely polarized spins that enter the free layer and exert a torque that tries to drive the free layer magnetization antiparallel to the direction of magnetization of the fixed layer.

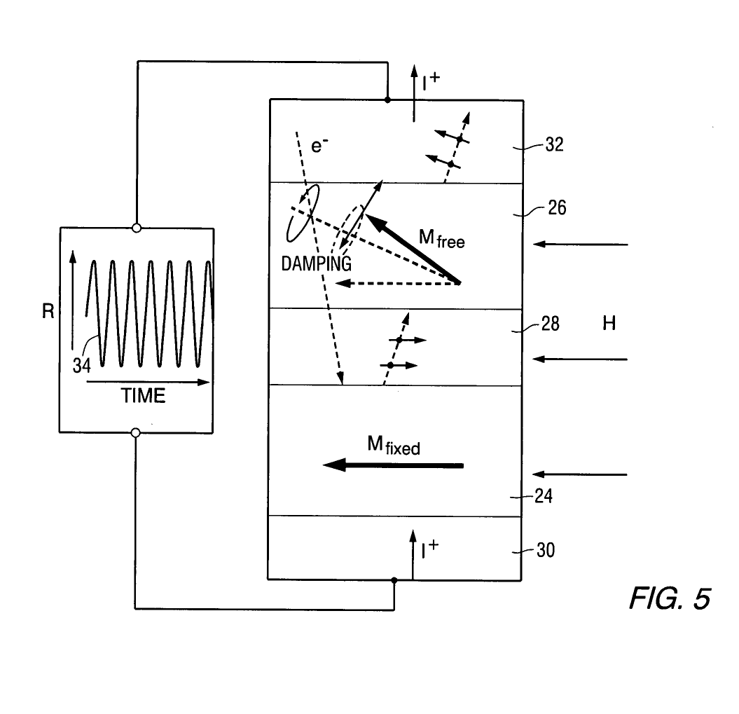

FIG. 3 depicts the case where the spin torque is effectively counterbalanced by the damping term (i.e., the second term) in Eq. 2, such that the free layer persists in a precessional state. The continuous fluctuation of the free layer with respect to the fixed layer magnetization can result in both an oscillating magnetic field and giant magnetoresistance (GMR) signal 34 in the form of a resistance or voltage across the stack, as depicted in FIG. 5. The characteristic frequencies of the signal fluctuations are in the microwave range (>GHz). Thus, a DC current is driving a tunable microwave source. In general, the frequency, f can be tuned by controlling the current and an applied bias field, where f tends to increase linearly with an increase in the applied field and decrease linearly with an increase in current.

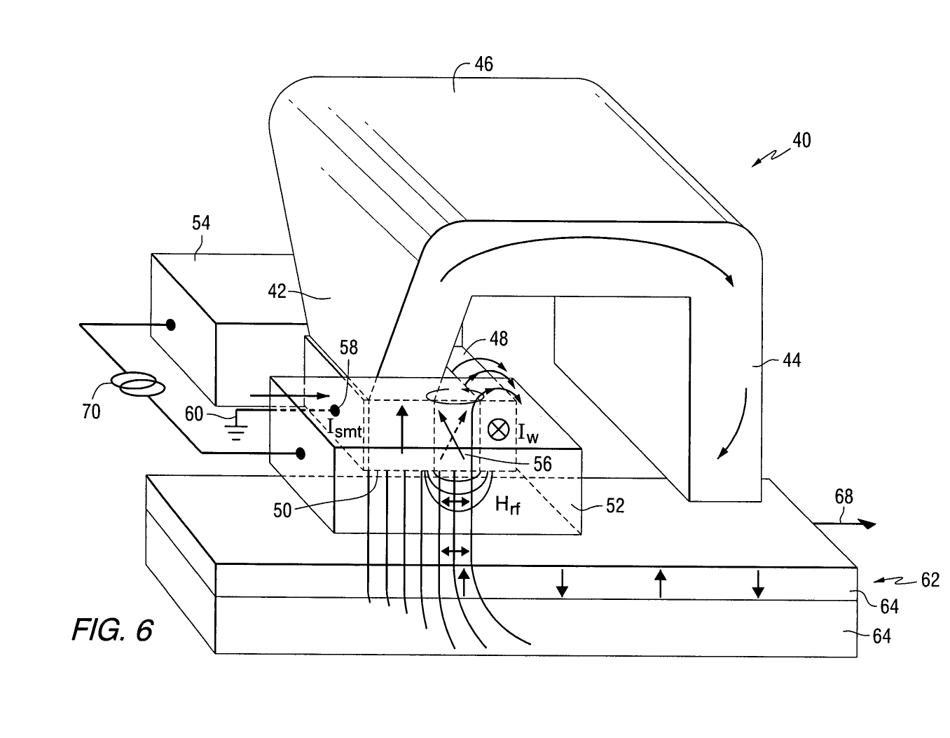

FIG. 6 is a three-dimensional rendering of a magnetic recording head 40 (also referred to as a writer), showing how such a spin momentum transfer (SMT) stack can be integrated with a WAMR writer in a perpendicular recording system. For an additional description of a WAMR writer, see, for example, U.S. Pat. No. 6,665,136 B2, the disclosure of which is hereby incorporated by reference. The head includes a first (or write) pole 42 and a second (or return) pole 44 that are magnetically coupled by a yoke 46. An ampere wire 48 is positioned between the first and second poles and adjacent to an air bearing surface 50 of the writer. First and second electrodes 52 and 54 are electrically connected to opposite sides of the wire 48. A magnetic free layer 56 is positioned between the first pole 42 and the wire 48. An electrical contact 58 and a conductor 60 are electrically connected to the first pole 42 to provide a path for the flow of spin momentum transfer current Iₛₘₜ. The writer is positioned adjacent to a magnetic storage medium 62, that includes a recording layer 64 and an underlayer 66. The recording medium and writer are mounted to provide relative movement between the writer and the medium as indicated by arrow 68.

A current source 70 supplies current to the wire 48. The write current IW passing through the wire 48 creates a WAMR write field H_{w} that passes through a portion of the storage medium. The integration of the SMT stack into the writer makes it possible to generate an rf field H_{rf} that superposes with the WAMR field to improve writability, as described and depicted for example, in FIGS. 1 and 2. Thus the SMT stack provides an integrated rf field source that improves the writing ability of the head.

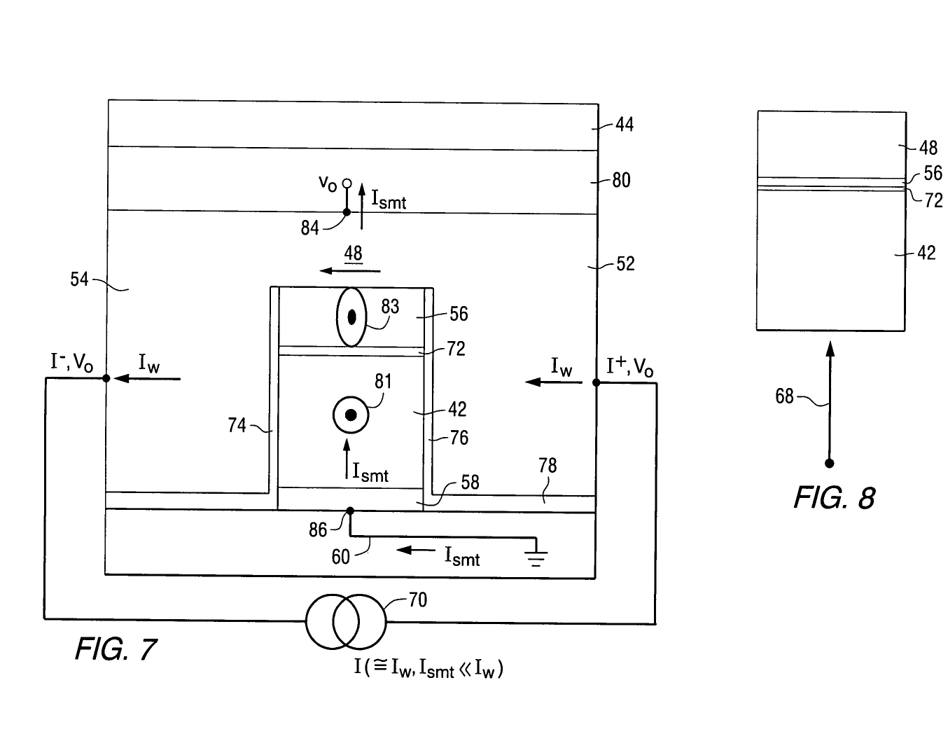

FIG. 7 shows a plan view of the air bearing surface of the recording head of FIG. 6. The write pole that is continuous with the yoke (see FIG. 6) acts as the fixed magnetic layer, and the free magnetic layer is sandwiched between the main pole and the ampere wire. There is an interlayer 72 between the fixed and free layers that couples the two layers magnetically and electrically, and can be either a conductor or an insulating tunnel barrier, both of which can be engineered to optimize the SMT. The pole/stack is electrically insulated from the WAMR leads by layers of insulation 74 and 76, except where the free layer is shorted to the bottom of the ampere wire. The stack is grounded through its base via contact 58 and conductor 60. An additional layer of insulation 80 is positioned between the wire 48 and the return pole 44. Arrow tips 81 and 83 represent the direction of magnetization of the pole 42 and the free layer 56, respectively. The oval shape of arrow tip 83 illustrates precession of the magnetization.

FIGS. 6 and 7 are not drawn to scale, as the SMT free layer and interlayer are typically of the order of 10 nm and 1 nm, respectively, while that of the pole would be more like 100 nm. Most of the figures have been drawn out of scale to illustrate the concept. The scale of a working device would be closer to that depicted in FIG. 8. In FIG. 8, arrow 68 illustrates the relative direction of movement of the media with respect to the recording head.

The WAMR writer is driven only by a current, I_{w}, in the wire, while the SMT stack is driven by a DC current, Iₛₘₜ. The current Iₛₘₜ results from a voltage applied between contact points 84 and 86. The polarity of Iₛₘₜ is shown in FIG. 7 and is such that the magnetization of the free layer is in a persistent precessional state, so as to generate an rf magnetic field. The polarity of Iₛₘₜ has a positive bias as discussed above and depicted in FIG. 3. A typical writer preamp has a common mode voltage that sets the WAMR leads and wire floating at a particular voltage, Vₒ, and this voltage is one possible source for driving the current through the stack (i.e., Iₛₘₜ=Vₒ/Rₛₘₜ, where Rₛₘₜ is the effective resistance through the stack to ground). In general, I_{w} will be of the order of 50-100 mA, while Iₛₘₜ can be less than 10 mA.

The current in the ampere (or WAMR) wire has the effect of driving the fixed and free layer magnetizations perpendicular to the ABS. This effectively acts as the fixed layer direction during a write cycle, although the magnetization switches between up and down throughout the write cycle. The polarity of Iₛₘₜ is the same whether the direction of magnetization of the pole is up or down. In general, the writer is driven at a frequency, or data rate, that is small compared to the rf frequency of the SMT device. Thus, for simplicity, the fixed layer magnetization can be treated as static.

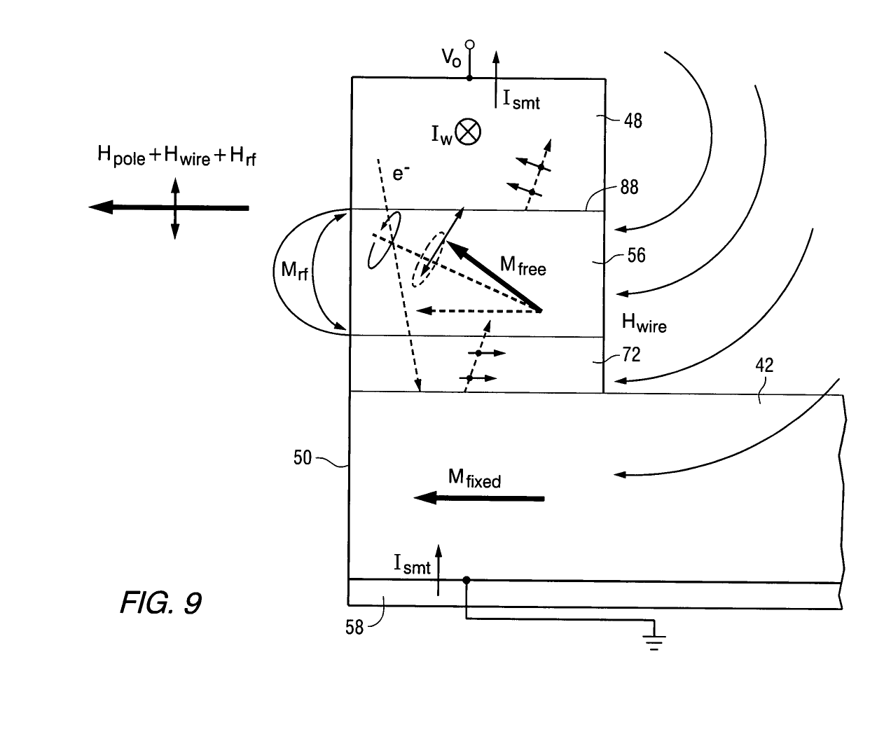

FIG. 9 is a cross-sectional side view of the writer of FIG. 7 near the ABS 50. The free layer pole 56 generates both a perpendicular field Hₚₒₗₑ and the rf field H_{rf}, while the field from the ampere wire H_{wire} acts as a bias field on the free layer that could drive the rf frequency into the tens of GHz. The net field at the media is the superposition of the “static” fields from the pole and wire, plus the rf field from the SMT oscillator, Hₙₑₜ=Hₚₒₗₑ+H_{wire}+H_{rf}. The field gradients should be such that the effective trailing edge of the pole coincides with the interface 88 between the top of the free layer and the bottom of the ampere wire.

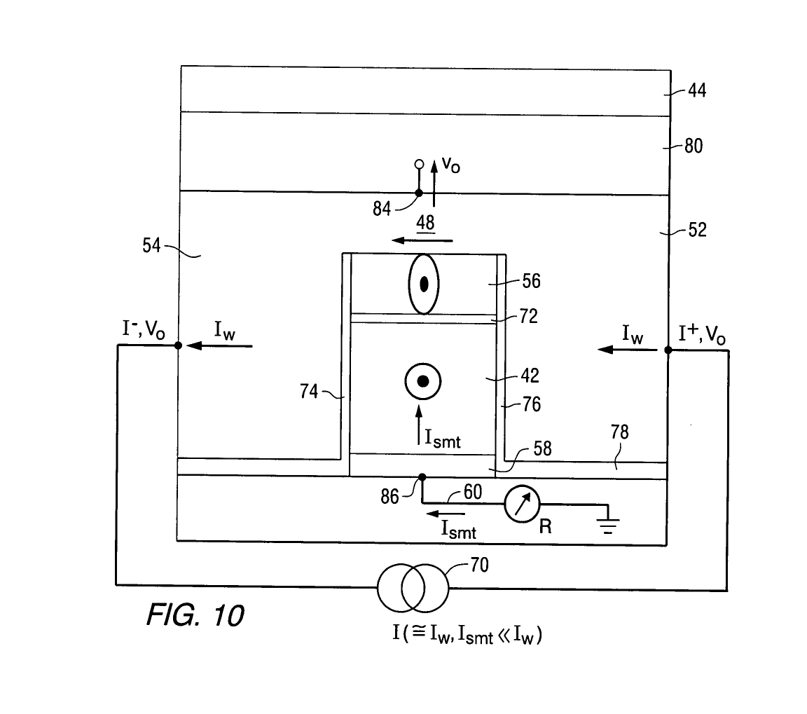

FIG. 10 is the same schematic as that of FIG. 8, with the addition of a variable resistor, R, in series with the stack and tied to ground. The resistor allows “on-the-fly” tuning of the SMT current, Iₛₘₜ[=Vₒ/(Rₛₘₜ+R)], for optimizing the rf output (e.g., frequency, field magnitude, power, etc.) of the SMT device. The variable resistor can be integrated with the head on the slider, or it can be off the slider and integrated with the drive electronics, such as by using a simple potentiometer.

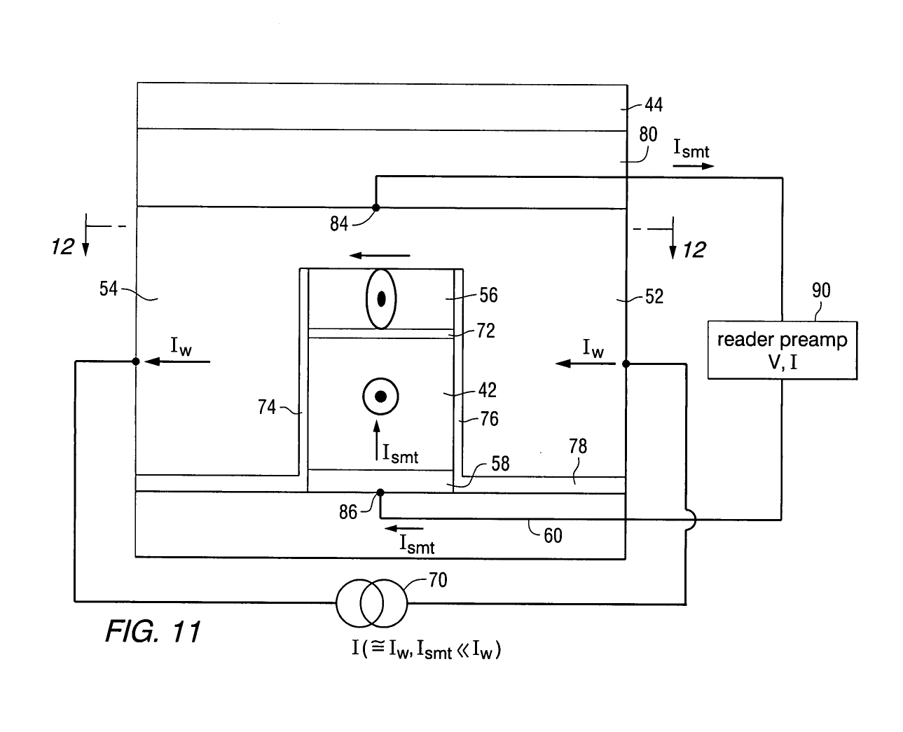

The SMT oscillator could also be driven by the reader preamp 90 rather than that of the writer, as depicted in FIG. 11. This has an advantage that the reader preamp is designed for biasing a device like the SMT stack, which operates at similar electronic design points as a reader, making control of the SMT device more straightforward than adapting the writer preamp for the purpose.

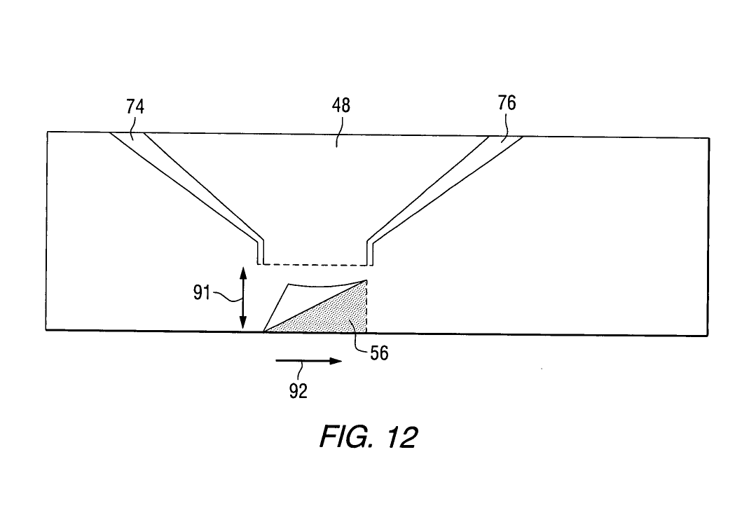

FIG. 12 is a cutaway showing the relative scale of the free layer area 56. This area is confined so that the current density through the layer is well defined and controllably large. The fabrication process used to pattern the nano-scale area of the free layer is realizable by self-alignment with the ampere wire in the “stripe height” direction 91 and with the fixed layer pole in the cross-track direction 92. For example, the free layer can be deposited and patterned along with the fixed layer so it has the same cross-track dimension, then it can be etched as part of the ampere wire definition, stopping on the interlayer or fixed layer, to define its stripe height.

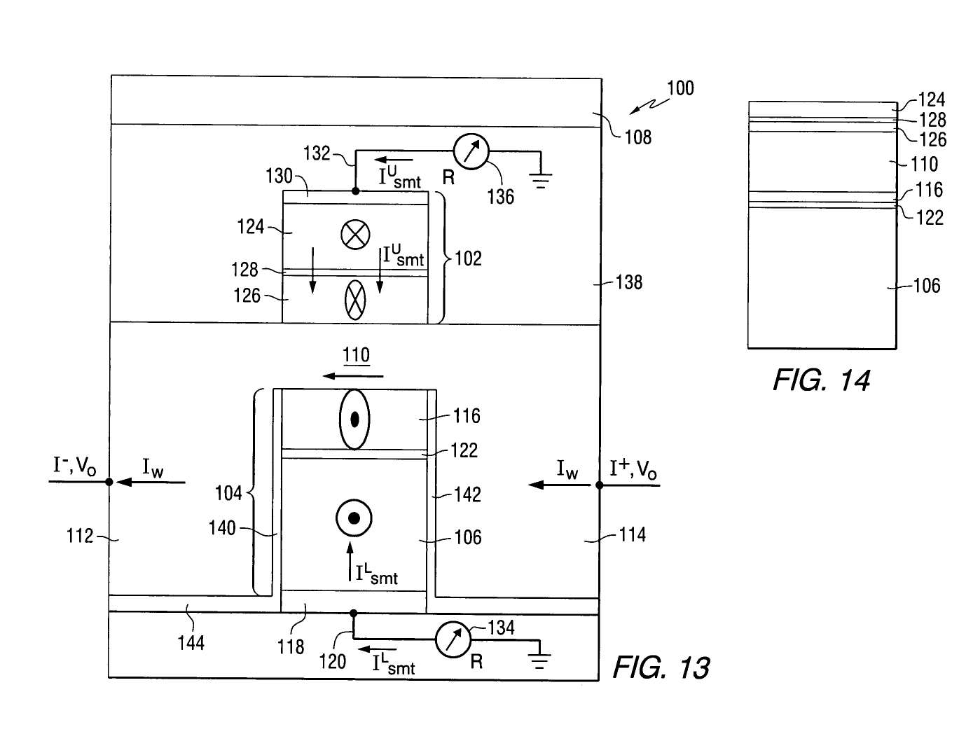

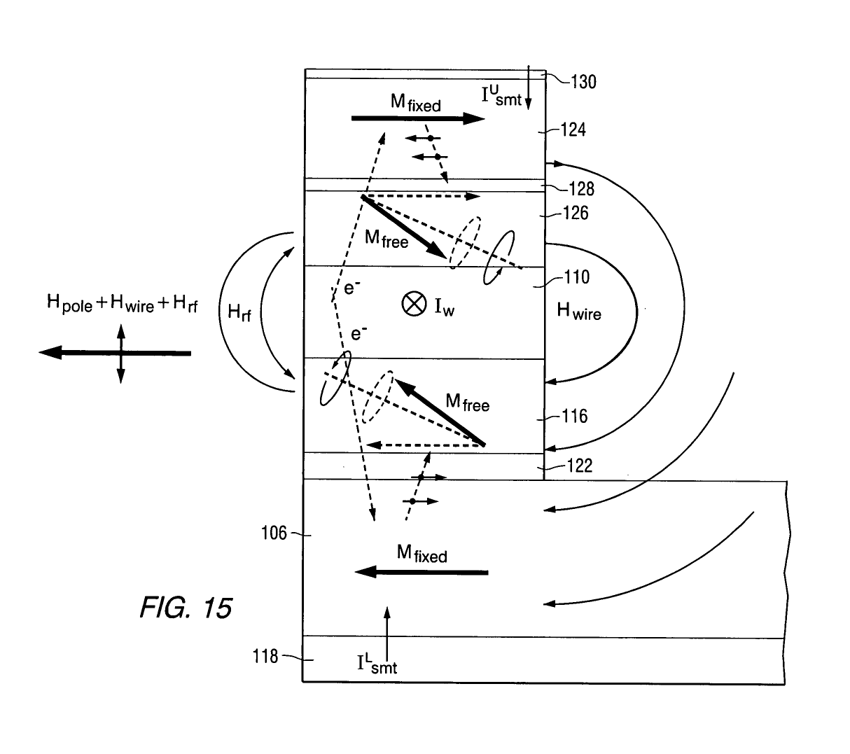

FIG. 13 is another recording head 100 that incorporates two spin momentum transfer stacks 102 and 104 that are configured to phase lock the free layers in a persistent precessional state. The writer includes a first (or write) pole 106 and a second (or return) pole 108 that are magnetically coupled by a yoke, not shown in this view. An ampere wire 110 is positioned between the first and second poles and adjacent to an air bearing surface of the writer. First and second electrodes 112 and 114 are electrically connected to opposite sides of the wire 110. A first magnetic free layer 116 is positioned between the first pole 106 and the wire 110. An electrical contact 118 and a conductor 120 are electrically connected to the first pole 106 to provide a path for the flow of spin momentum transfer current Iₛₘₜ. An interlayer 122 is positioned between the first pole and the first magnetic free layer. The writer further includes a second SMT stack that includes an antiparallel fixed layer 124, a second magnetic free layer 126 and a second interlayer 128 positioned between the antiparallel fixed layer 124 and the second magnetic free layer 126. An electrical contact 130 is provided on the antiparallel fixed layer 124 to connect a path 132 for the SMT current. Variable resistors 134 and 136 are provided to adjust the SMT current. The free layers are phase locked. Insulation 138 surrounds the second spin momentum transfer stack. Additional layers of insulation 140, 142 and 144 insulate the first spin momentum transfer stack from the contacts. For clarity, a more realistic scale of the device is shown in FIG. 14. One free layer is above the fixed layer pole, and below the ampere wire, and one is above the ampere wire and below a second (upper) fixed layer. In the latter case, the upper free and fixed layers are driven antiparallel to the pole by the field from the ampere wire (see FIG. 15). The stripe heights of both the lower and upper SMT stacks can be self-aligned with that of the ampere wire (see FIG. 15). The upper and lower stacks are each tied to ground such that opposite polarity currents, I^{U}ₛₘₜ and I^{L}ₛₘₜ, respectively, run through them to the ampere wire, which is biased from the writer preamp at voltage, Vₒ. Again, variable resistors (e.g., potentiometers, or the like) can be used to independently tune the currents through each stack. If I^{L}ₛₘₜ is positively biased and I^{U}ₛₘₜ is negatively biased as shown in FIG. 15, then spin momentum transfer leads to a spin torque on the free layers that tries to drive them each antiparallel with their respective fixed layers. As a result, the top and bottom free layers can, in principle, both be driven to persistent precessional states. However, typically this does not occur at the same current, so the device relies on the tunability of Iₛₘₜ and the phase locking and phase tuning of the two oscillators.

The ampere wire is thick enough that it acts to depolarize any current that flows between the upper SMT stack and the lower SMT stack, so the fixed layers only apply a torque to their respective free layers. In order to phase lock, the free layers should initially have frequencies close together and they must be coupled magnetically and/or electrically, all of which can be engineered through material properties and dimensions. In addition, electromagnetic coupling arises naturally from the described examples because the layers are electrically connected and they are close enough together to have at least magnetostatic coupling. Additionally, the phase difference between the precessing layers can be tuned to optimize the rf output. An advantage of this design is that the phase locked state can have a substantially higher power output and a sharper linewidth in frequency than that of the individual oscillators, or even their sum. Another advantage is that the two layers can double the magnetic charge and the field, while the physical gap between the free layers increases the spatial range of the rf field they generate, when optimally phased.

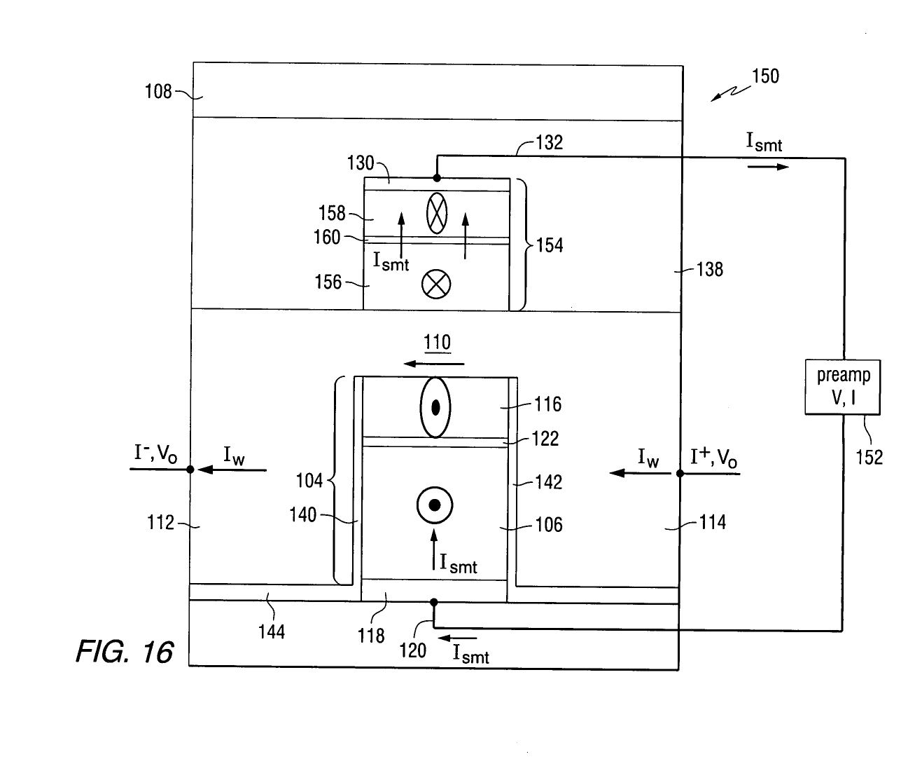

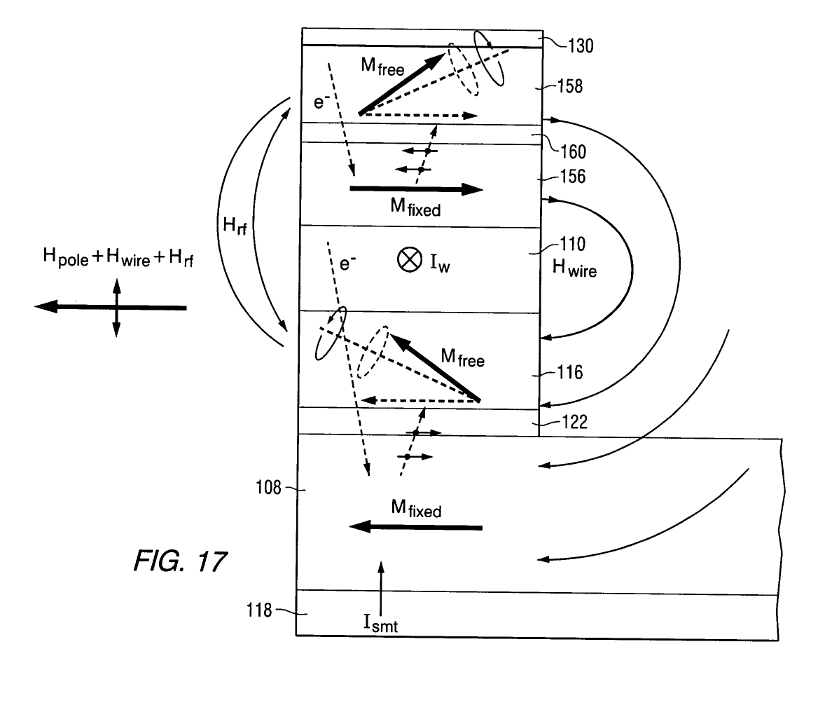

FIGS. 16 and 17 are similar to that of FIGS. 13 and 15, except that the upper and lower SMT stacks are driven by the same polarity bias current from an additional preamp 152. This requires that one of the stacks has the free layer and fixed layer inverted from that of FIG. 13. In the example of FIG. 16, the upper SMT stack 154 includes a fixed layer 156, a free layer 158 and an interlayer 160, and is subjected to a positive current bias. This geometry creates a somewhat larger gap between the two free layers since the upper fixed layer is now between the two free layers, creating a larger gap.

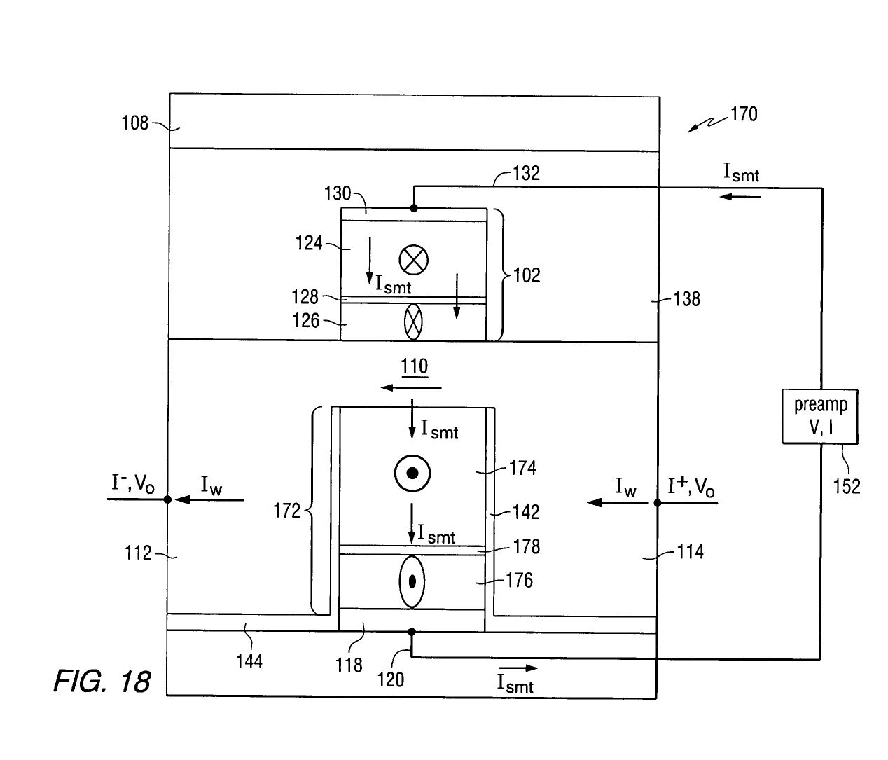

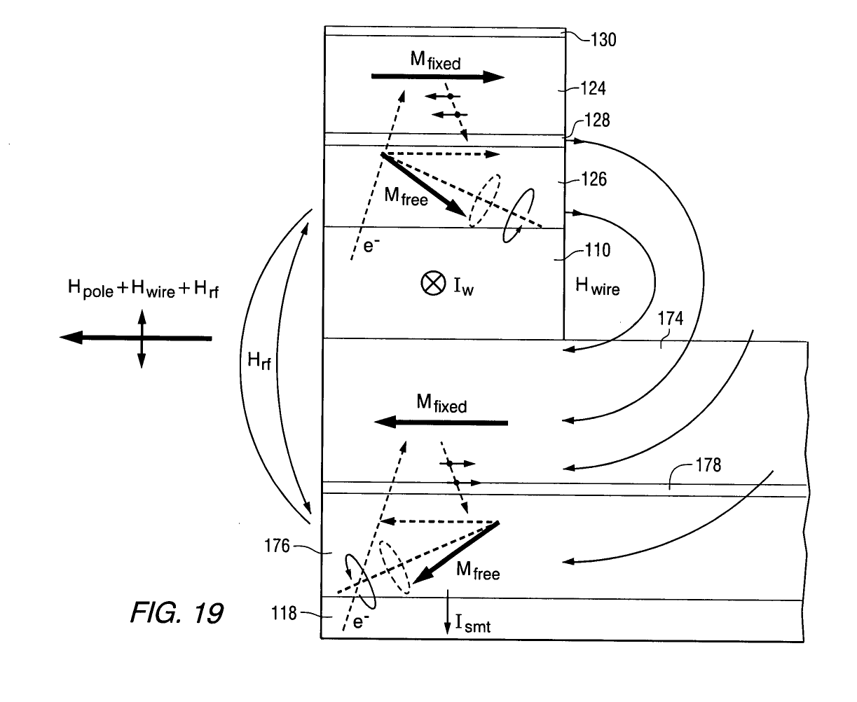

FIGS. 18 and 19 are similar to FIG. 13, except the lower free layer has been positioned below the fixed layer pole. This creates an even larger gap between the free layers, as the pole is typically about ten times thicker than the free layers (˜100 nm). The head 170 of FIGS. 18 and 19 includes a lower SMT stack 172 having a fixed pole layer 174, a free layer 176, and an interlayer 178.

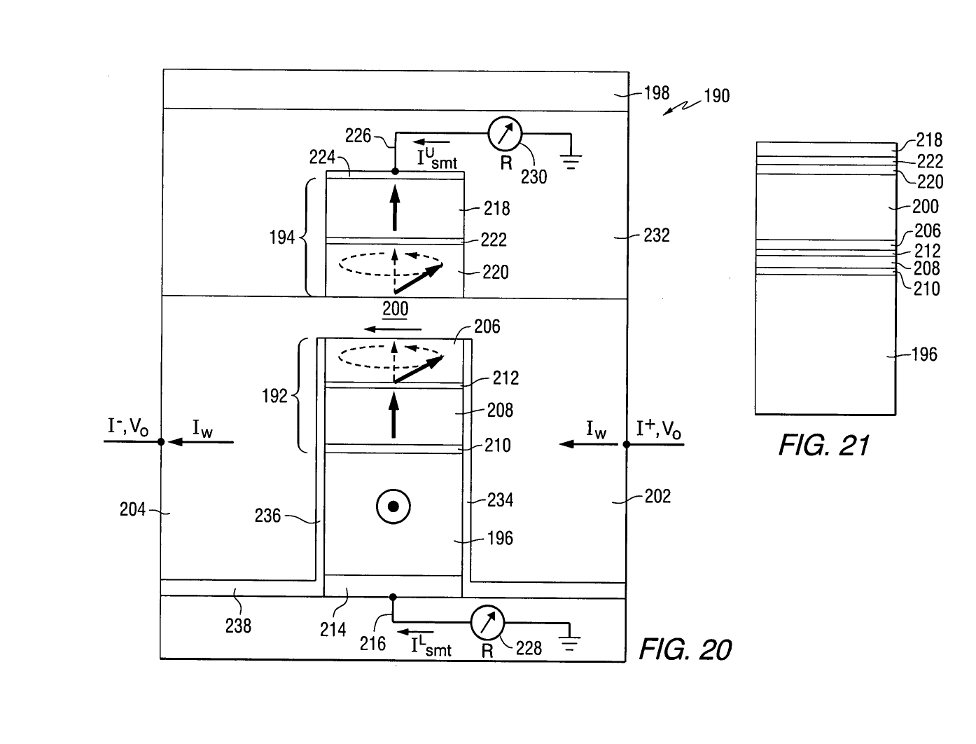

FIGS. 20, 21 and 22 demonstrate a similar design concept to that in FIG. 13, except the SMT layers have perpendicular, out-of-plane, anisotropy. FIGS. 20, 21 and 22 show another recording head 190 that incorporates two spin momentum transfer stacks 192 and 194. The writer includes a first (or write) pole 196 and a second (or return) pole 198 that are magnetically coupled by a yoke, not shown in this view. An ampere wire 200 is positioned between the first and second poles and adjacent to an air bearing surface of the writer. First and second electrodes 202 and 204 are electrically connected to opposite sides of the wire 200.

A first magnetic free layer 206 and a first magnetic fixed layer 208 are positioned between the first pole 196 and the wire 200. A first interlayer 210 is positioned between the pole 196 and the first magnetic fixed layer 208. A second interlayer 212 is positioned between the first magnetic free layer 206 and the first magnetic fixed layer 208. An electrical contact 214 and a conductor 216 are electrically connected to the first pole 196 to provide a path for the flow of spin momentum transfer current Iₛₘₜ.

The writer further includes a second SMT stack 194 that includes a second magnetic fixed layer 218, a second magnetic free layer 220 and an interlayer 222 positioned between the second magnetic fixed layer 218 and the second magnetic free layer 220. An electrical contact 224 is provided on the second magnetic fixed layer 218 to connect a path 226 for the SMT current. Variable resistors 228 and 230 are provided to adjust the SMT current. The free layers are phase locked. Insulation 232 surrounds the second spin momentum transfer stack. Additional layers of insulation 234, 236 and 238 insulate the first spin momentum transfer stack from the contacts.

For clarity, a more realistic scale of the device is shown in FIG. 21. One free layer is above the fixed layer pole and below the ampere wire, and one is above the ampere wire and below a second (upper) fixed layer.

In FIGS. 20, 21 and 22, the write pole still has in-plane anisotropy and no longer acts as a fixed layer in the SMT device. Instead, perpendicular fixed layers 208 and 218 are inserted below a lower perpendicular free layer and the ampere wire, and above an upper perpendicular free layer, respectively. Perpendicular orientation of the magnetization requires that the material's anisotropy field (Hₖ) points out-of-plane and is larger than its saturation magnetization. The anisotropy counters the demagnification field that normally drives a magnetization in the plane. Thus, the anisotropy should be large enough that the fields from the ampere wire do not significantly influence the magnetization. The perpendicular anisotropy allows for the maximum excursion angle on the free layer magnetization, allowing it to be rotated up to 90 degrees off axis by SMT torque, precessing entirely in the plane of the film. The phase difference between the two precessing free layers can be optimized to produce the maximum rf field output, e.g., when the magnetic poles at the ABS have a positive charge density on the surface of one free layer, they have the same charge density with the negative polarity on the other.

In FIGS. 20, 21 and 22, there is an interlayer between the lower fixed layer and the pole that acts to depolarize the spins of the current flowing between the layers. This is necessary so the spin-polarized current from the pole does not apply a torque to the lower fixed layer, and vice versa. The depolarizing interlayer can be one of many metals known in the field that are effective depolarizers. The layer thickness needs to be greater than the spin-diffusion length in the given material, which can be as small as 10 nm. However, this layer should be as thin as possible to minimize the gap between the pole and ampere wire, which is optimal for a WAMR writer. With this balance in mind, it should be possible to have a depolarizing layer on the order of 10 nm thick.

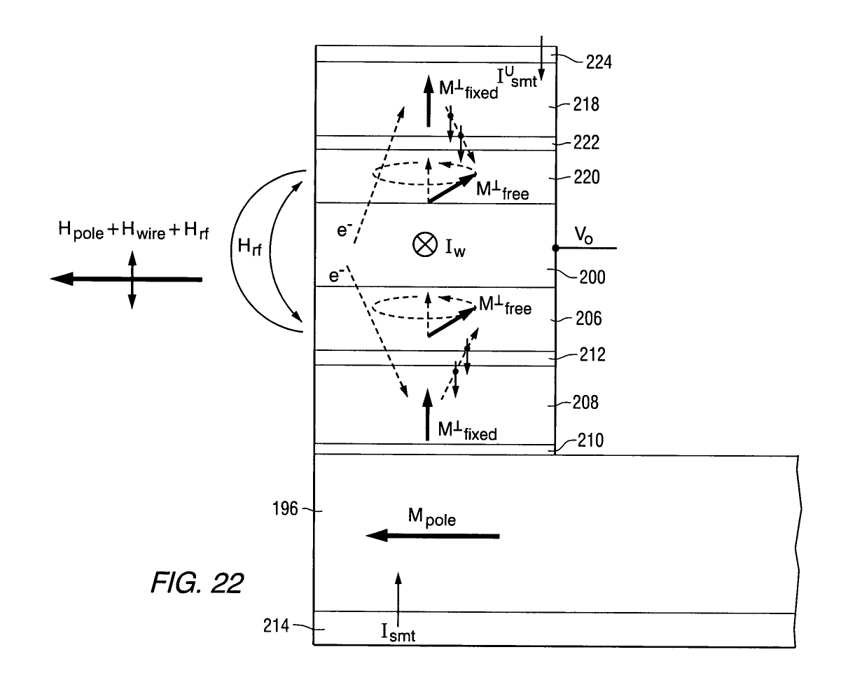

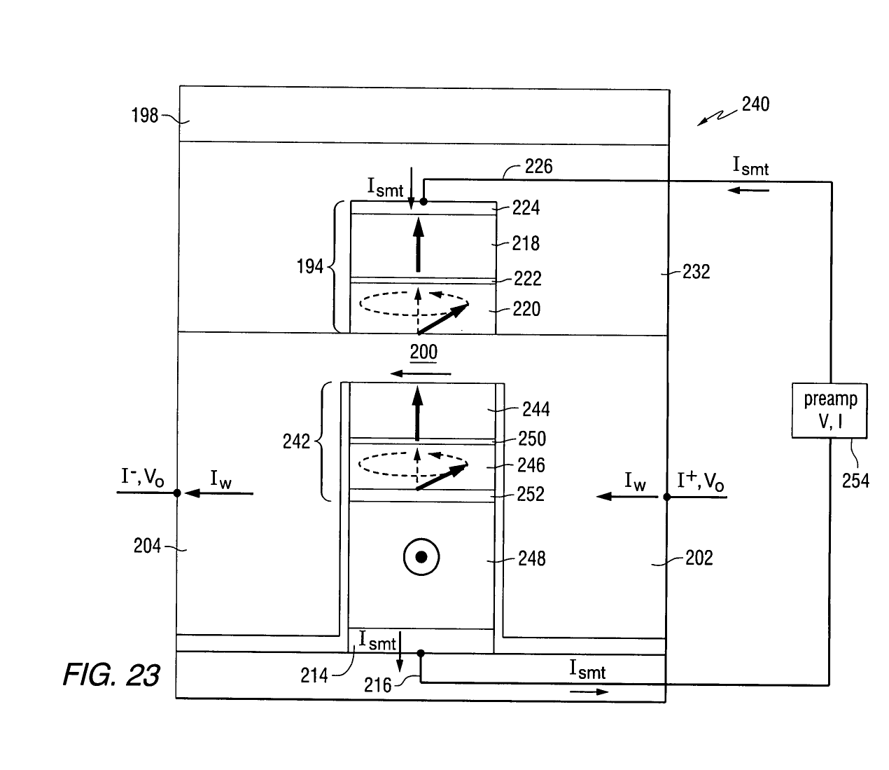

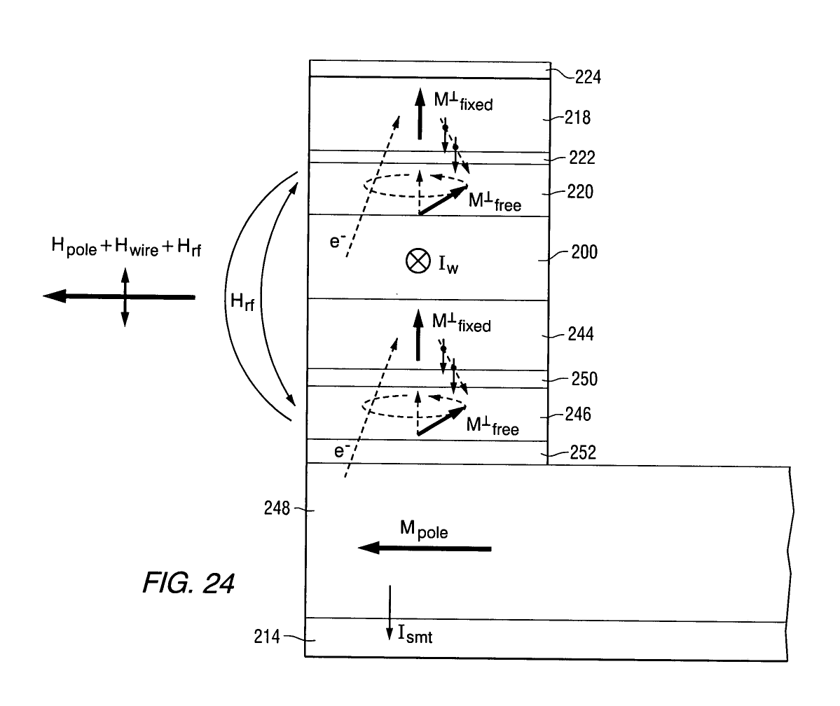

FIGS. 23 and 24 show another head 240. The head 240 of FIGS. 23 and 24 includes a lower SMT stack 242 having a fixed layer 244, a free layer 246, a first interlayer 250 between the fixed layer and the free layer, and a second interlayer 252 between the pole and the free layer. FIGS. 23 and 24 are similar to FIGS. 20 and 22, except that in the lower SMT stack 242 the free layer 246 has been positioned below the fixed layer 244 and above the pole 248.

FIGS. 23 and 24 are similar to FIGS. 20 and 22, but the SMT stacks are driven by a preamp 254 with the same polarity current bias. This also requires inverting one set of the SMT stacks, where in this example the lower free layer is placed below the lower fixed layer. This orientation will generate the appropriate SMT torque needed to maintain a persistent precessional state. There is an interlayer between the lower free layer and the pole that acts to depolarize the spins of the current flowing between the layers. This is necessary so the spin-polarized current from the fixed layer pole does not apply a torque to the lower free layer.

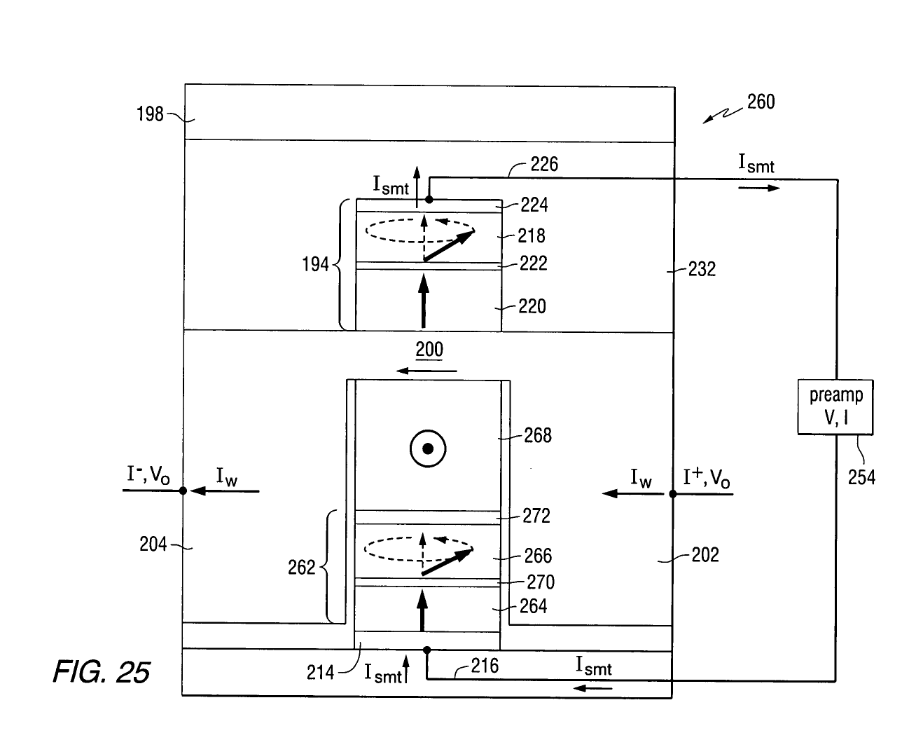

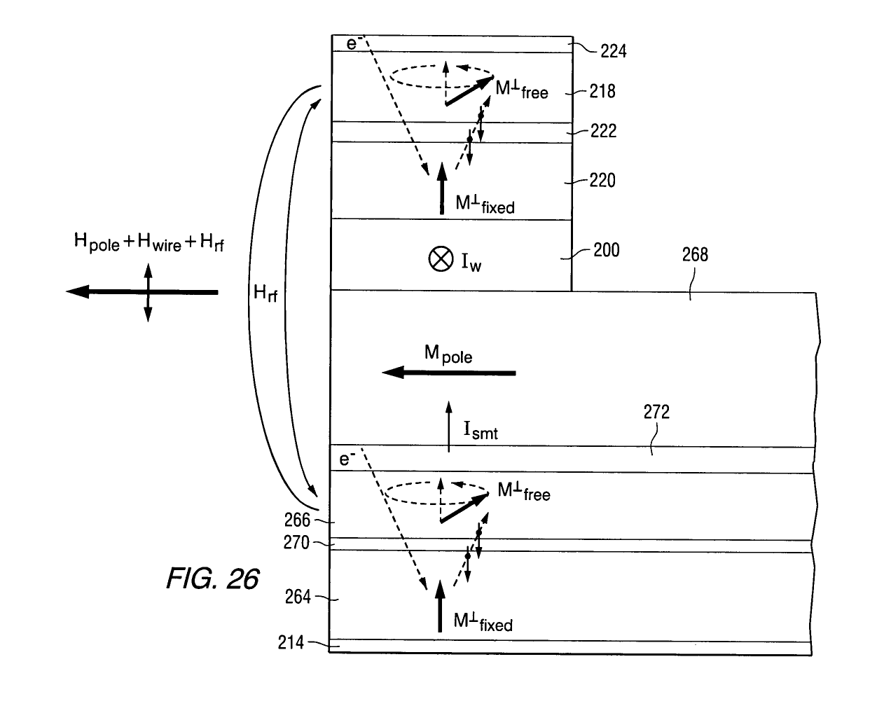

FIGS. 25 and 26 show another head 260. The head 260 of FIGS. 25 and 26 includes a lower SMT stack 262 having a fixed layer 264, a free layer 266, a first interlayer 270 between the fixed layer and the free layer, and a second interlayer 272 between the pole and the free layer.

FIGS. 25 and 26 are similar to FIGS. 23 and 24, except that in the lower SMT stack 262 the free layer 266 has been positioned above the fixed layer 264 and below the pole 268. This has the advantage that the pole 268 and ampere wire are as close as possible, which is generally optimum for WAMR, but the field from the phase locked SMT oscillators may be diminished by the larger gap between free layers.

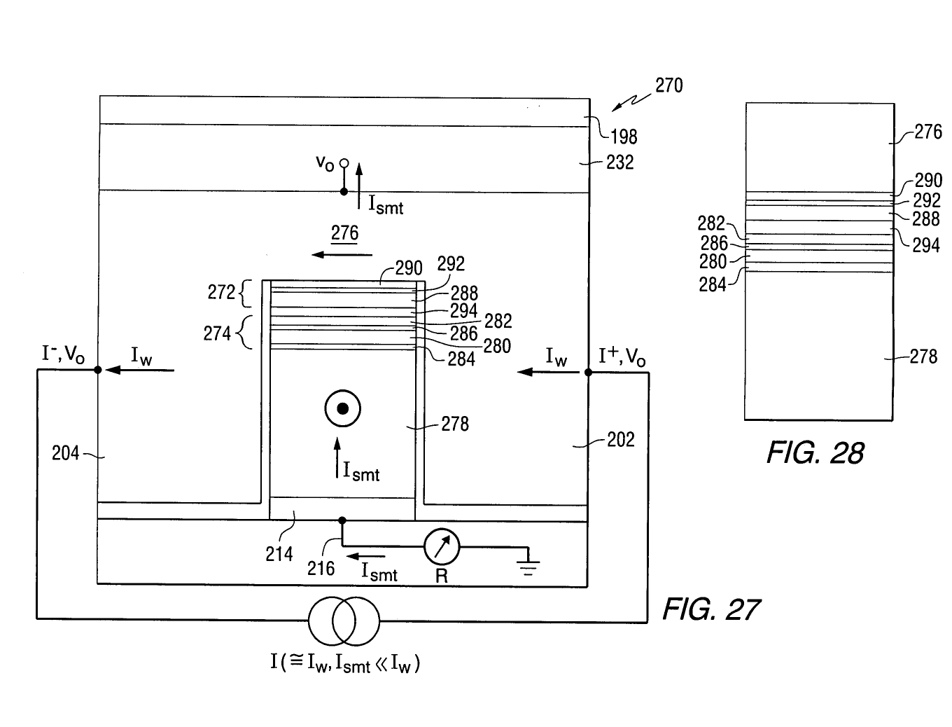

FIGS. 27 and 28 show another head 270. The head of FIGS. 27 and 28 incorporates the two SMT stacks 272 and 274 beneath the ampere wire 276. Stack 274 includes a perpendicular fixed layer 280 and a perpendicular free layer 282. A first interlayer 284 is positioned between the pole 278 and the perpendicular fixed layer 280. A second interlayer 286 is positioned between the fixed layer 280 and a perpendicular free layer 282. Stack 272 includes a perpendicular fixed layer 288, a perpendicular free layer 290, and a first interlayer 292 positioned between the perpendicular fixed layer 288 and the perpendicular free layer 290. A depolarizing layer 294 is positioned between the first and second stacks.

The bias current through the SMT stacks can be driven by the common mode voltage (Vₒ) of the writer preamp, or an independent preamp. There is an interlayer between the lower free layer and the upper fixed layer that acts to depolarize the spins of the current flowing between the layers. This is necessary so the upper fixed layer does not apply a torque to the lower free layer.

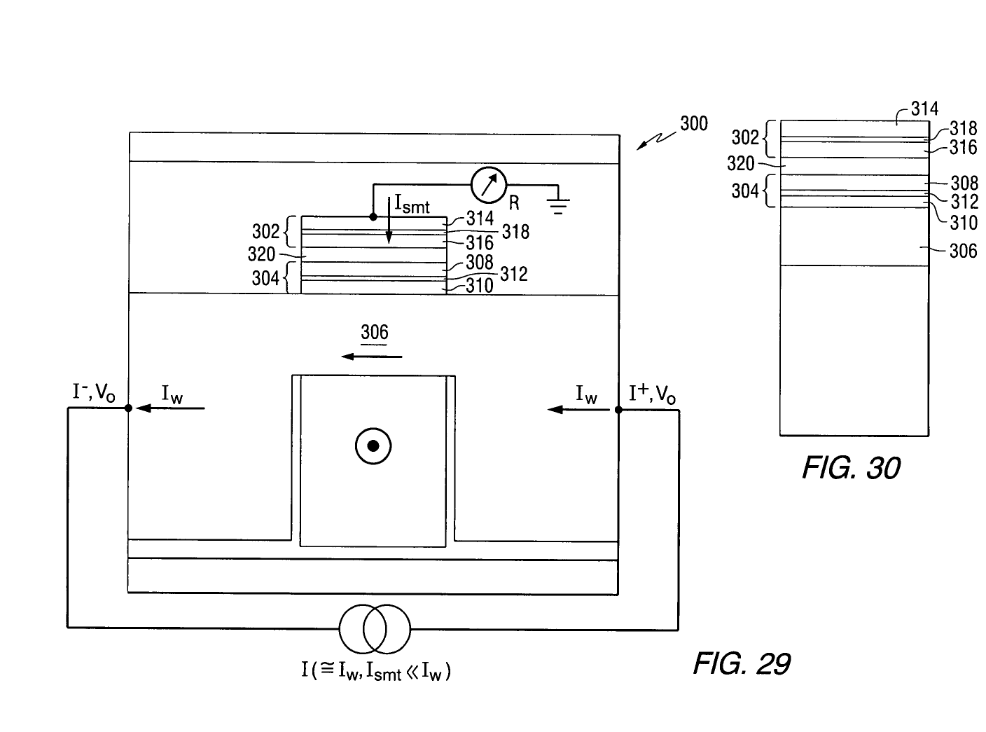

FIGS. 29 and 30 show another head 300. The head of FIGS. 29 and 30 incorporates the two SMT stacks 302 and 304 above the ampere wire 306. Stack 304 includes a perpendicular fixed layer 308, a perpendicular free layer 310, and a first interlayer 312 positioned between the perpendicular fixed layer 308 and the perpendicular free layer 310. Stack 302 includes a perpendicular fixed layer 314, a perpendicular free layer 316, and a first interlayer 318 positioned between the perpendicular fixed layer 314 and the perpendicular free layer 316. A depolarizing layer 320 is positioned between the first and second stacks.

The head of FIGS. 29 and 30 places the two SMT stacks above the ampere wire, which allows the ampere wire and the pole to be brought as close as possible.

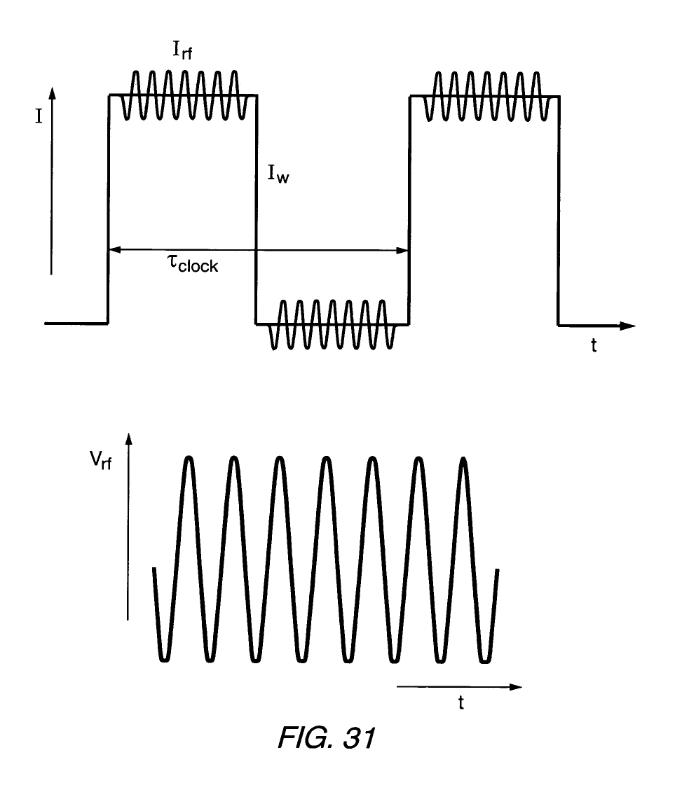

Either an rf current (top of FIG. 31) and/or rf voltage waveform (bottom of FIG. 31) can be integrated with the writer preamp and used to phase lock to the SMT oscillator as a means for boosting power from the SMT as well as tuning it. The rf frequency of the external current or voltage source should be close to that of the SMT oscillator in order for phase locking to occur. The power of the rf sources does not have to be large to induce phase locking as long as there is electronic coupling to the SMT. Since the power can be small, this makes implementation of a high frequency source reasonably inexpensive.

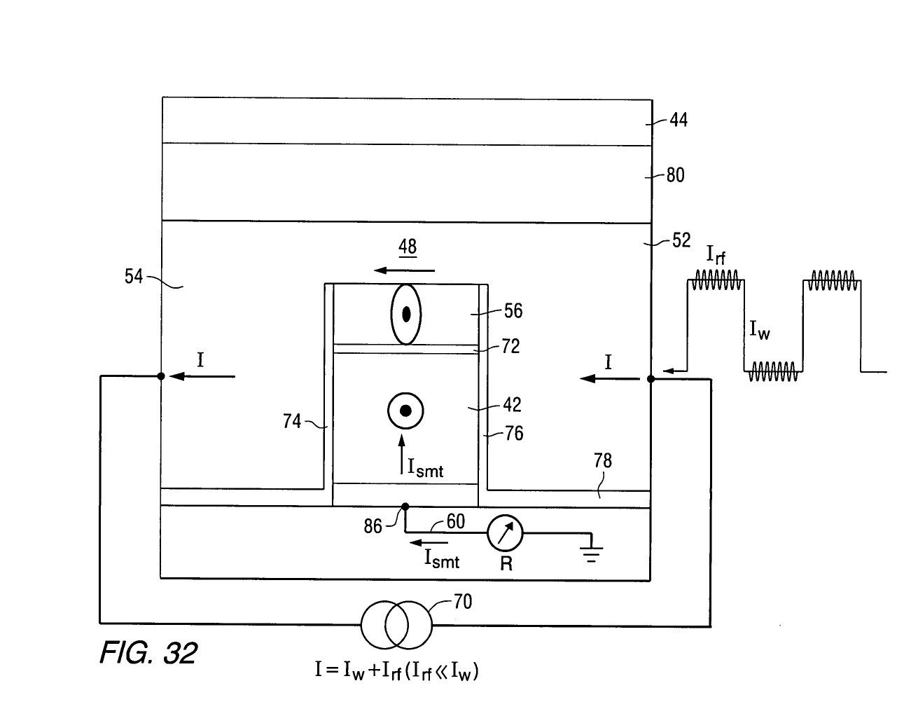

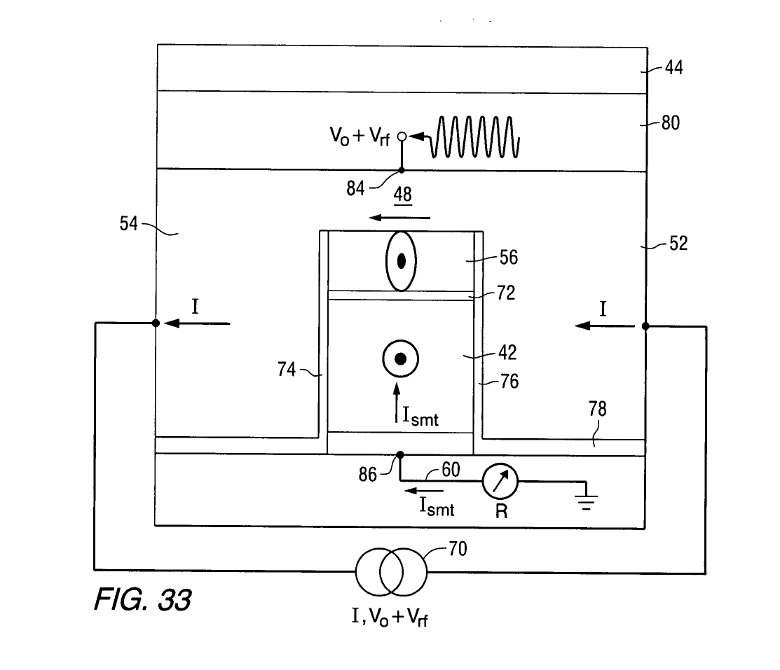

FIGS. 32 and 33 show how these sources can be integrated with the writer of FIG. 10 preamp and naturally coupled to the SMT. The amplitude and frequency of I_{rf}(f) can be varied to tune the output of the SMT oscillator. Similarly, the rf voltage source, V_{rf}(f), can be varied to tune the output of the SMT oscillator.

A further aspect of the invention is that there is an rf component to Iₛₘₜ, since Iₛₘₜ˜Vₒ/Rₛₘₜ(f), and Rₛₘₜ oscillates at a frequency f due to the persistent fluctuations of the free layer and the magnetoresistive character of the stack, as described in FIG. 5. Thus, an oscillating self field should be generated by Iₛₘₜ(f), H_{I}, that can be superposed with the rf field of the free layer (H_{free}), thus bolstering the net rf field, i.e., H_{rf}(f)˜H_{free}(f)+H_{I}(Iₛₘₜ, f). In principle, Iₛₘₜ can be tuned to optimize its self field contribution.

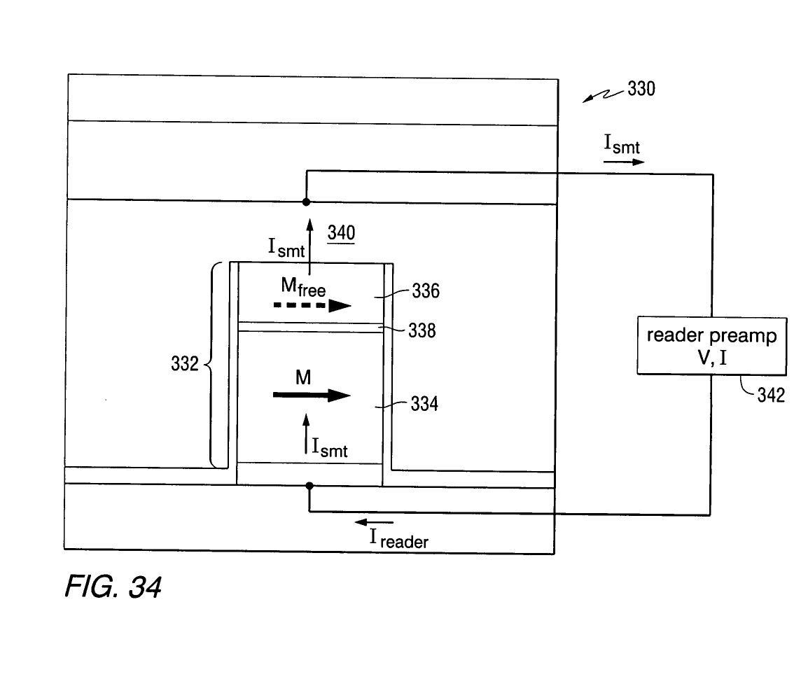

Since the SMT stack is a derivative of a current-perpendicular-to-the-plane (CPP) giant magnetoresistance (GMR) reader structure (or Tunneling MagnetoResistance (TMR) reader), the SMT stack could be designed to serve the dual purpose of a reader and the SMT oscillator for the writer. FIG. 34 shows a recording head 330 in which a magnetic stack (also referred to as a bilayer) 332 is used for reading data from a storage media. The stack includes a fixed magnetic layer 334 separated from a free magnetic layer 336 by an interlayer 338. An ampere wire 340 is positioned adjacent to the free layer 336. A reader preamp 342 is connected to the stack through the ampere wire and the base of the stack.

When reading, the ampere wire of the head is not energized, I_{w} is zero, and the SMT stack is biased for optimal reader performance by a reader preamp, as depicted in FIG. 34. In this case, the fixed and free layer magnetizations are not energized for writing, but are instead in their quiescent state, engineered for optimum reader performance. The free layer magnetization can rotate in response to the fields emanating from bits in the media, resulting in a magnetoresistive response across the SMT stack that acts as the readback signal. When writing, the WAMR writer is energized (I_{w}≠0) and the SMT stack is biased into the persistent precessional state for optimal writability, as discussed above.

The designs discussed above are not meant to be all-inclusive, as there are other geometries that could be beneficial to the invention and are natural extensions of the described examples. The free and fixed layer materials can be the typical transition metal ferromagnets such as Fe, Co, and Ni, or more exotic ferromagnetic materials, such as Heusler alloys, or the like. The interlayer can be a wide range of metals, such as Cu, as are typically used in GMR devices. The interlayer can also be an insulating tunnel barrier, such as AlO, TaO, MgO, and others that are well-known in the field. The magnitude of the rf assist field needed to significantly improve writability is not yet well established, but 1000 Oe is a reasonable order-of-magnitude target for a design point of, for example, ˜10% of Hₖ of the media. It is possible to generate an rf assist field of more than 1000 Oe with the described structures if the material layers are engineered optimally for thickness, Mₛ, spacing between layers, etc.

In one aspect, this invention provides a perpendicular WAMR writer with an integrated rf field source in the form of an SMT oscillator to improve WAMR writability. The SMT device produces an rf assist field that superposes with the WAMR field. The SMT oscillator can also be phase locked to a second rf field source to bolster its power output and increase the spatial range of the assist field it generates. The second rf field source can be, for example, a second SMT oscillator that is positioned in the writer, or an external oscillator. The external oscillator can be, for example, a preamp circuit. The concept enables higher areal density writing.

While the invention has been described in terms of several examples, it will be apparent to those skilled in the art that various changes can be made to the described examples without departing from the scope of the invention as set forth in the following claims.

What is claimed is:

1. An apparatus comprising:
a write pole;
a return pole;
a wire positioned between the write pole and the return pole;
a first free layer; and
a first interlayer positioned between the write pole and the first free layer.

2. The apparatus of claim 1, wherein:
the first free layer is positioned between the first interlayer and the wire.

3. The apparatus of claim 1, further comprising:
a current source for supplying current to the wire and spin momentum transfer current to the write pole, the first interlayer and the first free layer.

4. The apparatus of claim 3, further comprising:
a resistor for adjusting the spin momentum transfer current.

5. The apparatus of claim 1, further comprising:
a current source for supplying current to the wire; and
a preamplifier for supplying spin momentum transfer current to the write pole, the first interlayer and the first free layer.

6. The apparatus of claim 1, further comprising:
a first fixed layer;
a second free layer; and
a second interlayer positioned between the first fixed layer and the second free layer.

7. The apparatus of claim 6, wherein:
directions of magnetization of the first free layer and the second free layer are antiparallel.

8. The apparatus of claim 6, wherein:
the second free layer is positioned between the first fixed layer and the wire.

9. The apparatus of claim 6, wherein:
the first fixed layer is positioned between the second free layer and the wire.

10. The apparatus of claim 6, wherein:
the write pole is positioned between the first interlayer and the wire.

11. The apparatus of claim 6, further comprising:
a second fixed layer positioned between the write pole and the first free layer.

12. The apparatus of claim 11, wherein:
a direction of magnetization of the first and second fixed layers is substantially parallel to an air bearing surface.

13. The apparatus of claim 6, further comprising:
a second fixed layer positioned between the wire and the first free layer.

14. The apparatus of claim 6, further comprising:
a second fixed layer, wherein the write pole and the first free layer are positioned between the second fixed layer and the wire.

15. The apparatus of claim 1, further comprising:
a first fixed layer;
a second free layer;
a second interlayer positioned between the first fixed layer and the second free layer; and
a depolarization layer positioned between the first free layer and the first fixed layer.

16. An apparatus comprising:
a write pole;
a return pole;
a wire positioned between the write pole and the return pole;
a first magnetic stack;
a second magnetic stack; and
a depolarization layer positioned between the first and second magnetic stacks.

17. The apparatus of claim 16, wherein:
the first and second magnetic stacks are positioned between the wire and the return pole.

18. An apparatus comprising:
a write pole;
a return pole;
a wire positioned between the write pole and the return pole; and
a first radio frequency field source.

19. The apparatus of claim 18, wherein:
the first radio frequency field source is phase locked with a second radio frequency field source.

20. An apparatus comprising:
a write pole;
a return pole; and
a first radio frequency field source that is phase locked with a second radio frequency field source.
